(19) United States
(12) Patent Application Publication
(10) Pub. No.: US 2026/0016432 A1
(43) Pub. Date: Jan. 15, 2026

(54) MICROFLUIDIC DEVICES, MICROFLUIDIC SYSTEMS, AND METHODS FOR ASSESSING THERMOPHYSICAL PROPERTIES OF A FLUID

(71) Applicant: INTERFACE FLUIDICS LTD., CALGARY (CA)

(72) Inventors: VIKRAM SONI, EDMONTON (CA); SOURABH AHITAN, EDMONTON (CA); ALI ABEDINI, EDMONTON (CA)

(73) Assignee: INTERFACE FLUIDICS LTD., CALGARY, AB (CA)

(21) Appl. No.: 18/995,219

(22) PCT Filed: Jul. 21, 2023
(86) PCT No.: PCT/CA2023/050979

§ 371 Date: Jan. 16, 2025

Related U.S. Application Data
(60) Provisional application No. 63/391,819, filed on Jul. 25, 2022.

(51) Int. Cl. G01N 25/66; B01L 3/00

(52) U.S. Cl. CPC G01N 25/66; B01L 3/50273; B01L 2200/027; B01L 2300/14; B01L 2300/1805; B01L 2400/0406

(57) ABSTRACT

A microfluidic device includes a microfluidic substrate having a fluid inlet port, a fluid outlet port, and a control volume in fluid communication with the fluid inlet port and the fluid outlet port. The control volume includes a gas accumulation cell downstream of and in fluid communication with the fluid inlet port for accumulating a gas composition within the control volume, and a plurality of capillary channels downstream of the gas accumulation cell for collecting condensed liquid from the gas accumulation cell. The capillary channels each extend from the gas accumulation cell, and the depth of each of the capillary channels is less than the depth of the gas accumulation cell.

### CROSS-REFERENCES TO RELATED APPLICATIONS

This application claims priority to U.S. Provisional Patent Application No. 63/391,819 filed on Jul. 25, 2022, which is incorporated herein by reference in its entirety.

### FIELD

This document relates to microfluidics. More specifically, this document relates to microfluidic devices such as microfluidic chips, systems including microfluidic devices, and methods for assessing thermophysical properties of a fluid.

### BACKGROUND

U.S. Pat. No. 10,895,544 (Molla et al.) discloses a microfluidic apparatus having a microchannel that includes at least one vertically oriented segment with a top section having a relatively wide opening and a bottom section having a relatively narrow opening. The top section is larger in volume relative to the bottom sections, and the middle sections taper down in at least one dimension from the top section to the bottom section. One or tens or hundreds of vertically-oriented segments may be provided, and they are fluidly coupled to each other. Each segment acts as a pressure-volume-temperature (PVT) cell, and the microchannel apparatus may be used to determine a parameter of a fluid containing hydrocarbons such as the dew point of the fluid or the liquid drop-out as a function of pressure.

### SUMMARY

The following summary is intended to introduce the reader to various aspects of the detailed description, but not to define or delimit any invention.

Microfluidic devices for assessing thermophysical properties of a study fluid are disclosed.

According to some aspects, a microfluidic device for assessing thermophysical properties of a study fluid includes a microfluidic substrate having at least a first fluid inlet port, at least a first fluid outlet port, and at least a first control volume in fluid communication with the first fluid inlet port and the first fluid outlet port. The first control volume includes at least a first gas accumulation cell downstream of and in fluid communication with the first fluid inlet port for accumulating a gas composition within the first control volume, and a plurality of capillary channels downstream of the first gas accumulation cell for collecting condensed liquid from the gas accumulation cell. The capillary channels each extend from the first gas accumulation cell, and depth of each of the capillary channels is less than a depth of the first gas accumulation cell. The first fluid outlet port is downstream of and in fluid communication with the capillary channels.

In some examples, the depth of the first gas accumulation cell is micron-scale, and the depth of the capillary channels is nanometer-scale.

In some examples, the depth of the first gas accumulation cell is between about 1 micron and about 500 microns, or between about 10 microns and about 50 microns.

In some examples, the depth of each of the capillary channels is between about 80 nm and about 1 micron, or between about 100 nm and about 300 nm.

In some examples, a volume of the gas accumulation cell is between about 0.0000912 mm³ and about 0.0456 mm³, or between about 0.000912 mm³ and about 0.00456 mm³.

In some examples, a respective volume of each capillary channel is between about 0.000000432 mm³ and about 0.0000054 mm³, or between about 0.00000054 mm³ and about 0.00000162 mm³.

In some examples, a length of each respective capillary channel is between about 20 microns and about 500 microns, and a width of each respective capillary channel is between about 2 microns and about 80 microns. In some examples, the length of each respective capillary channel is between about 100 microns and about 300 microns, and the width of each respective capillary channel is between about 10 microns and about 50 microns.

In some examples, the gas accumulation cell has a periphery from which the capillary channels extend, and the gas accumulation cell further includes a plurality of pillars positioned around the periphery and adjacent the capillary channels to facilitate nucleation.

In some examples, the gas accumulation cell is generally linear. In some examples, the gas accumulation cell is generally U-shaped.

In some examples, the gas accumulation cell is in fluid communication with the first fluid inlet port via an inlet channel, and the microfluidic device further includes a bypass channel extending from the inlet channel and in fluid communication with a bypass outlet.

In some examples, the first fluid outlet port is in fluid communication with the capillary channels via a collection line system for collecting condensed liquid from the capillary channels. The collection line system can include a first collection line that is joined to and in fluid communication with each of the capillary channels, and a second collection line that extends from the first collection line towards the first fluid outlet port. The second collection line can be serpentine. A depth of the collection line system can be the same as the depth of the capillary channels.

In some examples, the plurality of capillary channels includes between 20 and 1000 capillary channels, or between 40 and 200 capillary channels.

Methods for assessing one or more thermophysical properties of a study fluid are also disclosed.

According to some aspects, a method for assessing one or more thermophysical properties of a study fluid includes: a. loading the study fluid into at least a first control volume of a microfluidic chip to fill at least a first gas accumulation cell of the microfluidic chip with the study fluid; b. after step a., adjusting an operating condition within the first control volume to a test condition, to condense a liquid from the study fluid, whereby the liquid flows from the first gas accumulation cell into a plurality of capillary channels extending from the first gas accumulation cell; and c. during and/or after step b., optically investigating at least some of the capillary channels to assess a phase state and/or volume of the study fluid in the capillary channels.

In some examples, in step b., the liquid flows from the first gas accumulation cell into the plurality of capillary channels at least partially by capillary action.

In some examples, in steps a., b., and c., the microfluidic chip is oriented horizontally.

In some examples, step c. includes at least one of: assessing a volume of the liquid in the capillary channels at the test condition, assessing a volume of a gas composition in the capillary channels at the test condition, assessing a volume of the liquid in the control volume at the test condition, assessing a volume of the gas composition in the control volume at the test condition, and assessing a condensate to gas ratio for the study fluid at the test condition.

In some examples, the method includes repeating steps b. and c. at subsequent test conditions.

In some examples, the method further includes plotting a phase envelope for the study fluid.

In some examples, the operating condition is pressure. In some examples, the operating condition is temperature.

In some examples, in step a., the study fluid is a supercritical fluid, and step b. includes isothermally depressurizing the control volume to condense the liquid from the supercritical fluid.

In some examples, in step a., the study fluid is a traditional gas, and step b. includes isothermally pressurizing the control volume to condense the liquid from the traditional gas.

Microfluidic systems for assessing one or more thermophysical properties of a study fluid are also disclosed.

According to some aspects, a microfluidic system for assessing one or more thermophysical properties of a study fluid includes a microfluidic device having at least a first fluid inlet port, at least a first fluid outlet port, and at least a first control volume in fluid communication with the first fluid inlet port and the first fluid outlet port. The control volume includes at least a first gas accumulation cell downstream of and in fluid communication with the first fluid inlet port for accumulating a gas composition within the first control volume, and plurality of capillary channels downstream of the first gas accumulation cell for collecting condensed liquid from the first gas accumulation cell. The capillary channels each extend from the first gas accumulation cell, and a depth of each of the capillary channels is less than a depth of the gas accumulation cell. The first fluid outlet port is downstream of and in fluid communication with the capillary channels. A study fluid injection sub-system is in fluid communication with the first fluid inlet port for forcing a study fluid into the first control volume to fill the control volume. A pressure regulation sub-system regulates the pressure in the first control volume. A manifold supports the microfluidic device and provides fluid communication between the microfluidic device, the study fluid injection sub-system, and the pressure regulation sub-system. A temperature regulation sub-system regulates the temperature in at least the first control volume. An optical investigation sub-system allows for optical access to least a portion of the first control volume.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a perspective view of an example microfluidic device;

FIG. 2 is a plan view of the microfluidic device of FIG. 1, in which a control volume of the microfluidic device is encircled in dotted line;

FIG. 3 is plan view of the control volume of the microfluidic device of FIGS. 1 and 2;

FIG. 4 is an enlarged plan view of a portion of the control volume of the microfluidic device of FIGS. 1 and 2;

FIG. 5 is a further enlarged plan view of a portion of the control volume of the microfluidic device of FIGS. 1 and 2;

FIG. 6 is a schematic view of an example microfluidic system;

FIG. 7 is a flow chart of an example method for assessing one or more thermophysical properties of a study fluid;

FIGS. 8A to 81 are photographs of a portion microfluidic device, showing the formation of liquid droplets as equilibrium is reached at the dew point pressure of a study fluid;

FIG. 9 is a plan view of another example microfluidic device, in which a control volume of the microfluidic device is encircled in dotted line;

FIG. 10 is plan view of the control volume of the microfluidic device of FIG. 9;

FIG. 11 is an enlarged plan view of a portion of the control volume of the microfluidic device of FIG. 9;

FIG. 12 is a plan view of another example microfluidic device, in which a control volume of the microfluidic device is encircled in dotted line;

FIG. 13 is plan view of the control volume of the microfluidic device of FIG. 12;

FIG. 14 is an enlarged plan view of the encircled portion of the control volume of FIG. 13;

FIG. 15 is a plan view of another example microfluidic device; and

FIG. 16 is an enlarged plan view of a portion of the microfluidic device of FIG. 15, where a control volume is encircled in dotted line.

### DETAILED DESCRIPTION

Various apparatuses or processes or compositions will be described below to provide an example of an embodiment of the claimed subject matter. No embodiment described below limits any claim and any claim may cover processes or apparatuses or compositions that differ from those described below. The claims are not limited to apparatuses or processes or compositions having all of the features of any one apparatus or process or composition described below or to features common to multiple or all of the apparatuses or processes or compositions described below. It is possible that an apparatus or process or composition described below is not an embodiment of any exclusive right granted by issuance of this patent application. Any subject matter described below and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

Numerous specific details are set forth in order to provide a thorough understanding of the subject matter described herein. However, it will be understood by those of ordinary skill in the art that the subject matter described herein may be practiced without these specific details. In other instances, well-known methods, procedures and components have not been described in detail so as not to obscure the subject matter described herein. The description is not to be considered as limiting the scope of the subject matter described herein.

The terms “coupled” or “coupling” or “connected” or “connecting” as used herein can have several different meanings depending on the context in which these terms are used. For example, these terms can have a mechanical, fluid, electrical or communicative connotation. For further example, these terms can indicate that two or more elements or devices are directly connected to one another or connected to one another through one or more intermediate elements or devices via an electrical element, electrical signal, or a mechanical element depending on the particular context. For further example, these terms can indicate that two or more elements or devices are connected to one another such that fluid may flow between the elements or devices.

As used herein, the wording “and/or” is intended to represent an inclusive-or. That is, “X and/or Y” is intended to mean X or Y or both. As a further example, “X, Y, and/or Z” is intended to mean X or Y or Z or any combination thereof. Furthermore, the phrase “at least one of X, Y, and Z” is intended to mean only X (i.e. one or multiple of X), or only Y (i.e. one or multiple of Y), or only Z (i.e. one or multiple of Z), or any combination X, Y, and Z.

Terms of degree such as “substantially”, “about”, and “approximately” as used herein mean a reasonable amount of deviation of the modified term such that the end result is not significantly changed. These terms of degree may also be construed as including a deviation of the modified term if this deviation would not negate the meaning of the term it modifies.

Any recitation of numerical ranges by endpoints herein includes all numbers and fractions subsumed within that range, including the endpoints (e.g. 1 to 5 includes 1, 1.5, 2, 2.75, 3, 3.90, 4, and 5). It is also to be understood that all numbers and fractions thereof are presumed to be modified by the term “about”.

As used herein, the term “assess” includes (but is not limited to) determination, calculation, estimation, quantification, modelling, prediction, analysis, testing, and study. For example, the statement that “microfluidic devices can be used to assess a volume of a study fluid” indicates that microfluidic devices can be used to determine, calculate, estimate, quantify, model, predict, analyze, test, and/or study the volume of a study fluid.

As used herein, the term “study fluid” refers to any fluid assessed by the devices, systems, and methods disclosed herein. Example study fluids include gas compositions, refrigerants, water methane blends, and/or consumer chemicals. Study fluids can be, for example, liquids, or gas compositions, or a combination thereof.

As used herein, the term “gas composition” refers to a composition from which liquid may be condensed, including by retrograde condensation. A “gas composition” may include materials that are in a traditional gas phase, such as dry gases, natural gases, free gases, and wet gases, from which liquid may be condensed by increasing pressure or reducing temperature. A “gas composition” may include materials that are in a supercritical phase (also referred to as “supercritical fluids”), from which liquid may be condensed by decreasing pressure or increasing temperature. A “gas composition” may be synthetic or naturally derived. A “gas composition” may be, for example, a solution gas (e.g. a portion of a crude oil that has been distilled or otherwise separated from the crude oil). A “gas composition” may be a sample that resembles (e.g. has a composition substantially similar to) a light crude oil fraction. A “gas composition” may further include materials in one or more other states. For example, a “gas composition” may be a combination of a traditional gas and a liquid, or a supercritical fluid and a liquid. A “gas composition” can be a single-component composition or a multi-component composition.

As used herein, the term “thermophysical property” can refer to (but is not limited to) one or more of the following parameters of a study fluid: volume (e.g. volume of one or more liquid droplets or slugs of a study fluid, and/or volume of a quantity of a gas composition), phase state (e.g. whether a study fluid is in a gaseous state, a liquid state, a supercritical state, a solid state, or a combination thereof), presence, absence, or change of a component (e.g. presence or absence of asphaltene solids, gas hydrates, a bubble, and/or dew), conditions under which a component appears, disappears, or changes (e.g. asphaltene onset pressure, dew point pressure, bubble point pressure, dew point temperature, dew point pressure, gas hydrate formation conditions of a study fluid), phase envelope, and ratio of one phase state to another (e.g. gas-to-oil ratio).

Generally disclosed herein are microfluidic devices in the form of microfluidic chips, systems incorporating microfluidic devices, and related methods. The microfluidic devices, systems, and methods can be used to assess one or more thermophysical properties of study fluids. For example, the microfluidic devices, systems, and methods can be used in the oil and gas industry, in order to predict behavior of gas compositions in oil-bearing subterranean formations (e.g. in shale and/or tight oil formations, as well as fracture zones (also known as “frac zones”) created in such formations during hydraulic fracturing). More specifically, the microfluidic devices, systems, and methods can be used, for example, in order to assess the thermophysical properties of a gas composition. For example, the microfluidic devices, systems, and methods can be used to assess the dew point pressure and/or temperature of a gas composition, to assess the liquid drop out volume of gases, to plot a phase envelope for a gas composition, and/or to assess a gas to oil ratio (GOR) of a gas composition. In some particular examples, the microfluidic devices, systems, and methods can be used to assess the dew point of retrograde gas condensates.

In general, the microfluidic devices, systems, and methods disclosed herein can in some examples allow for fast, inexpensive, and/or reliable assessment of the thermophysical properties of gas compositions or other study fluids. More specifically, the microfluidic devices, systems, and methods disclosed herein can in some examples allow for fast, inexpensive, and/or reliable assessment of thermophysical properties such as dew point pressure, phase envelope, and condensate gas ratio (CGR). For example, the phase envelope of a gas composition can be assessed in a matter of hours (as opposed to days), using only a small volume of gas composition (e.g. less than 10 mL), with minimal labor and cost. Furthermore, the systems and methods disclosed herein can be automated and precisely controlled, which can allow for accuracy as well as reduced costs and reduced manpower.

In general, the microfluidic devices disclosed herein can include one or more control volumes (i.e. at least a first control volume). Each control volume includes one or more gas accumulation cells (i.e. at least a first gas accumulation cell), and a plurality of capillary channels (e.g. up to 1000 capillary channels) downstream of and extending from each respective gas accumulation cell. The depth of the capillary channels can be less than the depth of the gas accumulation cell from which the capillary channels extend (e.g. the depth of a given gas accumulation cell can be micron-scale, and the depth of a given set of capillary channels can be nanometer-scale). In use, the control volume(s) can be filled with a study fluid, in particular a gas composition. An operating condition, such as pressure or temperature, can then be adjusted. For example, in the case of a supercritical fluid exhibiting retrograde condensation behavior, while holding the operating temperature constant at a test temperature, the operating pressure can be decreased to a test pressure, to cause a liquid to condense from the supercritical fluid in the gas accumulation cell(s). Alternatively, in the case of a dry gas or a wet gas, while holding the operating temperature constant at a test temperature, the operating pressure can be increased to a test pressure, to cause a liquid to condense from the dry gas or wet gas in the gas accumulation cell(s). In either case, due to capillary action, the condensed liquid will then flow from the gas accumulation cell(s) into the capillary channels. An optical investigation can then be conducted, to assess a phase state and/or volume of the study fluid in the capillary channels. For example, a volume of the liquid in the capillary channels (or the control volume(s) as a whole) can be assessed, and/or a volume of supercritical fluid, dry gas, or wet gas in the capillary channels (or the control volume(s) as a whole) can be assessed. These volumes can be used to calculate a condensate to gas ratio for the study fluid at the test temperature and pressure.

As mentioned above, in the microfluidic devices described herein, the depth of the capillary channels can be less than the depth of the gas accumulation cell(s) from which the capillary channels extend. The relatively large depth of the gas accumulation cell(s) allows for a sufficient volume of the gas composition to accumulate within the control volume(s), while the relatively small depth of the capillary channels allows for extremely small droplets or slugs of liquid to be identified and for the volume thereof to be quantified. For example, volumes as small as femtolitres of liquid can be identified and the volume thereof can be quantified. For further example, liquid drop-out volumes of less than 0.01% can be identified and the volume thereof can be quantified.

Furthermore, as mentioned above, in the microfluidic devices described herein, condensed liquid can flow from the gas accumulation cell(s) into the capillary channels by capillary action. In other words, liquid is wicked into the capillary channels. As such, the microfluidic devices can be used in any orientation. That is, as the microfluidic devices do not rely solely on gravity for the collection of condensed liquid, the microfluidic devices need not be held such that the capillary channels are oriented vertically and positioned below the gas accumulation cell(s). For example, in use, the microfluidic devices can be oriented horizontally.

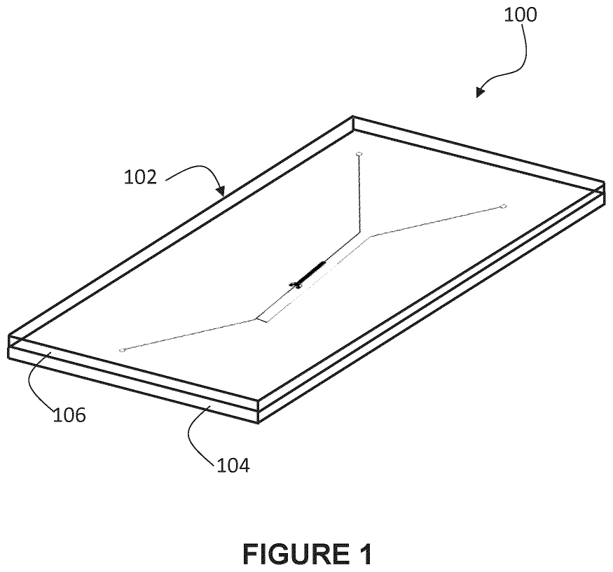

Referring now to FIG. 1, an example microfluidic device 100 is shown. The microfluidic device 100 may also be referred to as a “microfluidic chip”. The microfluidic device 100 includes a microfluidic substrate 102 that has various microfluidic features therein (i.e. fluid cells, fluid channels, and fluid ports, described in further detail below). The microfluidic substrate 102 allows for optical investigation (e.g. imaging, optionally with the use of an optical microscope and/or video recording equipment and/or a photographic camera) of at least some of the microfluidic features.

Referring still to FIG. 1, in the example shown, the substrate 102 includes a base panel 104 in which the microfluidic features are etched and/or drilled, and a cover panel 106 that is secured to the base panel 104 and that covers the microfluidic features. In the example shown, the base panel 104 is an opaque silicon panel, and the cover panel 106 is a transparent glass panel. In alternative examples, the substrate 102 may be of another configuration. For example, both the base panel 104 and the cover panel 106 can be a transparent glass panel, or the base panel 104 can be a transparent glass panel while the cover panel 106 can be an opaque silicon panel.

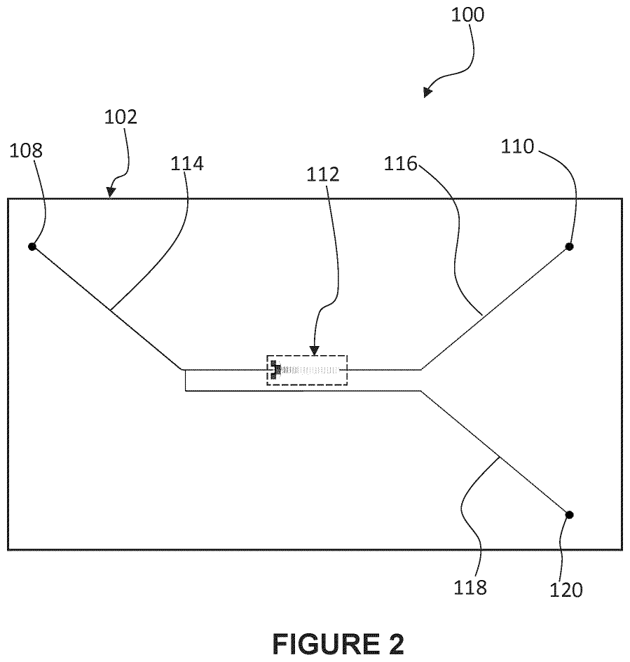

Referring now to FIG. 2, in the example shown, the substrate 102 includes a first fluid inlet port 108, a first fluid outlet port 110, and a control volume 112 (encircled in dotted line, and described in greater detail below) between the first fluid inlet port 108 and the first fluid outlet port 110. The control volume 112 is in fluid communication with the first fluid inlet port 108 via an inlet channel 114, and is fluid communication with the first fluid outlet port 110 via an outlet channel 116. The substrate 102 further includes a bypass channel 118, which extends from the inlet channel 114, and which is in fluid communication with a bypass outlet 120.

The terms “inlet port”, “inlet channel”, “outlet port”, “outlet channel”, “bypass outlet”, and “bypass channel” are used herein for simplicity, and are not intended to limit the use of these ports and channels. For example, while the inlet port 108 may in many examples be used to load a study fluid into the microfluidic device 100, it may in other examples be used for egress of materials from the microfluidic device 100.

In alternative examples, the substrate can include another number of channels and ports (i.e. at least one fluid inlet port and at least one fluid outlet port, and at least one inlet channel and at least one outlet channel). For example, the bypass channel 118 and bypass outlet 120 can be omitted. Furthermore, the inlet channel, bypass channel, and outlet channel may be of a variety of configurations, such as branched or non-branched, generally straight, or non-straight (e.g. serpentine).

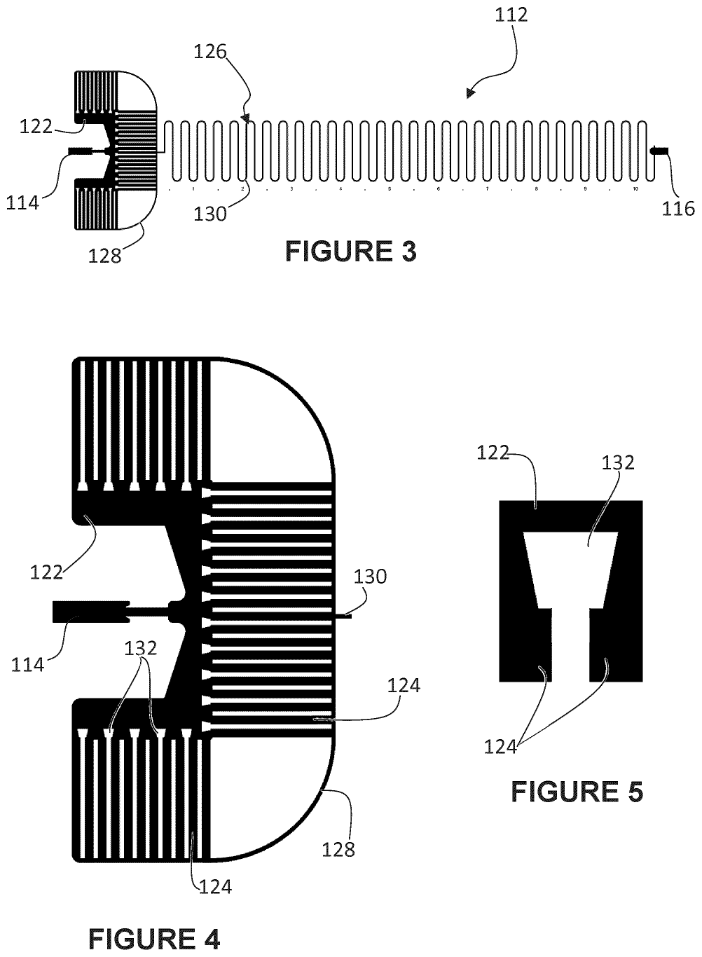

Referring now to FIGS. 3 and 4, in the example shown, the control volume 112 generally includes a gas accumulation cell 122, a plurality of capillary channels 124 (only two of which are labelled, and only in FIG. 4), and a collection line system 126 (labelled in FIG. 3). In FIGS. 3 and 4, areas depicted with black fill are open areas in which fluids may accumulate or flow (e.g. the gas accumulation cell 122 is depicted with black fill), while areas in white are solid (e.g. the walls of the capillary channels 124 are shown in white)

In the example shown, the gas accumulation cell 122 is downstream of and in fluid communication with the first fluid inlet port 108 (not visible in FIGS. 3 and 4) via the inlet channel 114. The gas accumulation cell 122 serves to accumulate a gas composition, in particular relatively large volumes of a gas composition, within the control volume 112. For example, the gas accumulation cell 122 can have a depth that is relatively large, such as on the micron-scale. For example, the depth of the gas accumulation cell 122 can be between about 1 micron and about 500 microns, or more specifically between about 10 microns and about 50 microns. In some particular examples, the depth of the gas accumulation cell 122 is 20 microns. The relatively large depth provides the gas accumulation cell with a relatively large volume. For example, the gas accumulation cell 122 can have a volume of is between about 0.0000912 mm³ and about 0.0456 mm³, or more specifically between about 0.000912 mm³ and about 0.00456 mm³.

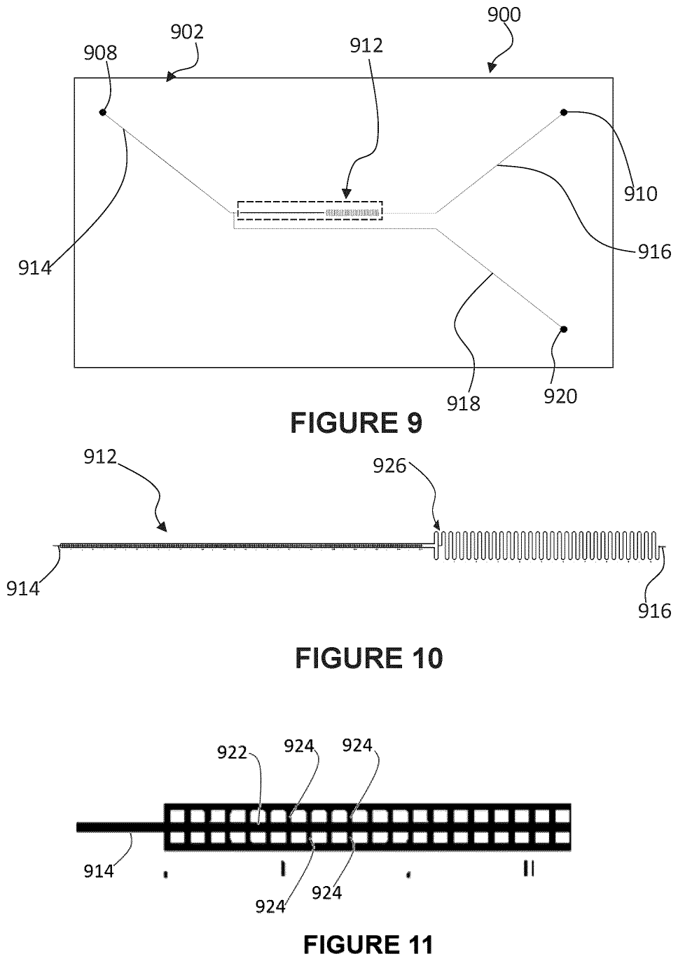

In the example shown, the gas accumulation cell 122 is generally U-shaped; however, various other shapes are possible (e.g. as shown in FIGS. 9 to 16 and as described below).

Referring to FIG. 4, in the example shown, the capillary channels 124 are downstream of the gas accumulation cell 122, and each capillary channel extends from the gas accumulation cell 122. In particular, in the example shown, the gas accumulation cell 122 has a periphery, and the capillary channels 124 are positioned around the periphery and extend generally radially outwardly from the periphery. Preferably, a relatively large number of capillary channels 124 are provided, such as between about 20 capillary channels and about 1000 capillary channels, or more specifically, between about 40 capillary channels and about 200 capillary channels. In the example shown in FIGS. 1 to 4, 42 capillary channels 124 are provided.

In use, the capillary channels 124 serve to collect condensed liquid from the gas accumulation cell 122. This can be at least partly achieved by capillary action, whereby condensed liquid forms a film in the gas accumulation cell 122 and is then wicked into the capillary channels 124. In order to achieve wicking and to allow for relatively small volumes of liquid (e.g. femtolitres) to be visualized in the capillary channels (e.g. using an optical microscope) and for the volume thereof to be quantified (e.g. using image analysis software), the depth of the capillary channels 124 is relatively small—i.e. less than the depth of the gas accumulation cell 122. For example, the capillary channels 124 can have a depth that is nanometer-scale, such between about 80 nm and about 1 micron, or more specifically between about 100 nm and about 300 nm. In some particular examples, the depth of the capillary channels 124 is about 200 nm. The depth of all of the capillary channels 124 can be the same, or some of the capillary channels 124 can have a different depth from others.

Furthermore, the length of each respective capillary channel 124 can be, for example, between about 20 microns and about 500 microns, or more specifically between about 100 microns and about 300 microns. The width of each respective capillary channel 124 can be, for example between about 2 microns and about 80 microns, or more specifically between about 10 microns and about 50 microns. The volume of each respective capillary channel 124 can be, for example, between about 0.000000432 mm³ and about 0.0000054 mm³, or more specifically between about 0.00000054 mm³ and about 0.00000162 mm³.

Referring to FIGS. 3 and 4, in the example shown, the collection line system 126 is downstream of and in fluid communication with each of the capillary channels 124, and is in fluid communication with the first fluid outlet port 110 (not shown in FIGS. 3 and 4) via the outlet channel 116. The collection line system 126 serves to collect condensed liquid from the capillary channels 124 as the capillary channels 124 fill with liquid. The collection line system 126 can be of a variety of configurations. In the example shown, the collection line system 126 includes a first collection line 128 that is generally U-shaped and is joined to and in fluid communication with each of the capillary channels 124, and a second collection line 130 that extends from the first collection line 128 towards the first fluid outlet port 110 and is generally serpentine. To facilitate visualization of liquid and quantification of the volume of liquid within the collection line system 126, the depth of the collection line system 126 may be relatively small. For example, the depth of the collection line system 126 may be the same as the depth of the capillary channels 124 (e.g. nanometer-scale). Furthermore, to allow for the collection of a relatively large volume of liquid, the length of the collection line system 126 may be relatively large. This can be achieved with the use of a serpentine shape, as shown.

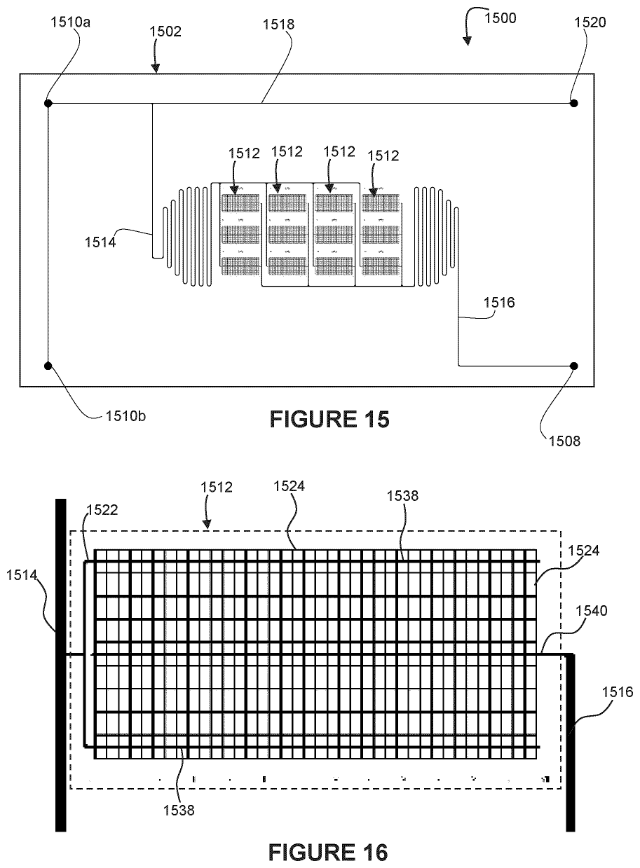

In alternative examples, the collection line system may be omitted, and the control volume may be connected to the first fluid outlet port in another fashion. For example, a control volume may include a secondary gas accumulation cell that is downstream of the capillary channels and that provides fluid communication between the capillary channels and the outlet channel (e.g. as is described with respect to FIGS. 15 and 16).

Referring now to FIG. 5, in the example shown, the control volume 112 further includes a plurality of nucleation facilitators in the form of pillars 132. The pillars 132 are positioned around the periphery of the gas accumulation cell 122 and adjacent the capillary channels 124. The pillars 132 facilitate nucleation of liquid droplets proximate the capillary channels 124.

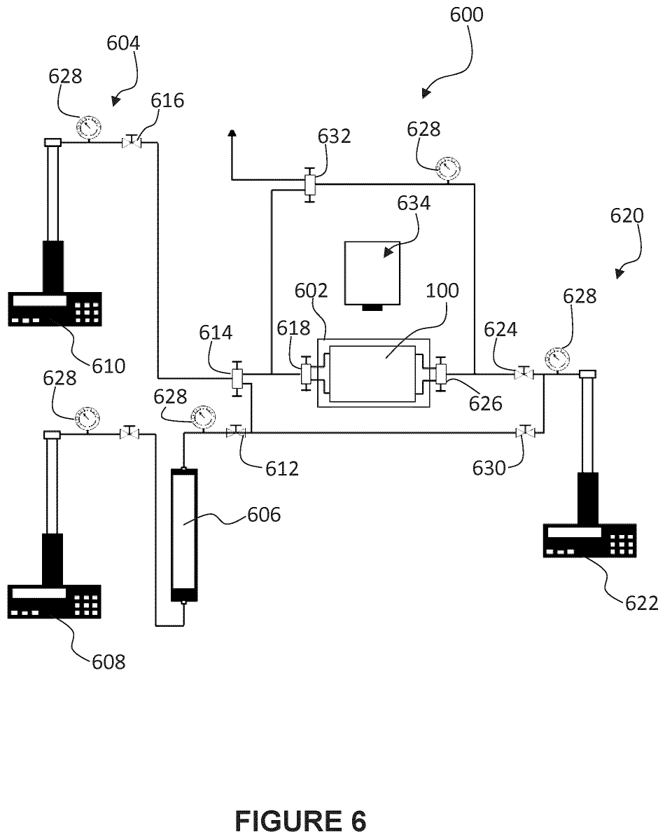

Referring now to FIG. 6, an example microfluidic system 600 is shown. As shown, the microfluidic system 600 includes the microfluidic device 100 of FIGS. 1 to 5; however, in alternative examples, the microfluidic system 600 can include various other microfluidic devices, such as those described below with regards to FIGS. 9 to 16. Furthermore, the microfluidic devices described herein can be used in various other microfluidic systems.

Referring still to FIG. 6, in the example shown, the microfluidic device 100 is supported by a manifold 602 (which can also be referred to as a “holder”), which supports the microfluidic device 100, helps to distribute pressures across the microfluidic device 100, helps to heat or cool the microfluidic device 100, and provides for fluid communication between other parts of the system 600 (e.g. a study fluid injection sub-system and a pressure regulation sub-system, as described below) and the microfluidic device 100. Examples of suitable holders are described in international patent application publication no. WO 2020/037398 (de Haas et al.), U.S. patent application publication no. 2020/0309285 (Sinton et al.), and international patent application publication no. WO 2022/251951 (de Haas et al.), which are incorporated herein by reference in their entirety.

Referring still to FIG. 6, the microfluidic system 600 further includes a study fluid injection sub-system 604, which is in fluid communication with the first fluid inlet port 108 (not shown in FIG. 6) of the microfluidic chip 100 via the manifold 602, for forcing a study fluid into the control volume 112 (not shown in FIG. 6) to fill the control volume 112. In the example shown, the study fluid injection sub-system 604 includes a storage cylinder 606 that houses the study fluid, and a pump 608 that maintains the storage cylinder 606 at a desired storage pressure. The study fluid injection sub-system 604 further includes a second pump 610, which is usable to force the study into the microfluidic chip 100. The second pump 610 is connected to the storage cylinder 606 via valves 612, 614, and 616. The second pump 610 is further connected to the fluid inlet port 108 of the microfluidic chip 100 via valves 614, 616, and 618, and the manifold 602.

Referring still to FIG. 6, the microfluidic system 600 further includes a pressure regulation sub-system 620, for regulating the pressure within the microfluidic device 100 (in particular, for regulating the pressure within the control volume 112). In the example shown, the pressure regulation sub-system 620 includes a backpressure regulator in the form of a third pump 622. The third pump 622 is connected to the fluid outlet port 110 (not shown in FIG. 6) of the microfluidic chip 100 via the manifold 602, and valves 624 and 626. The pressure regulation sub-system 620 further includes various pressure transducers 628, for monitoring the pressure in the system 600. The pressure regulation sub-system is connected to the study fluid injection sub-system via valves 630 and 632.

In alternative examples, the pressure regulation sub-system and the study fluid injection sub-system can be integrated as a single sub-system.

The microfluidic system 600 further includes a temperature regulation sub-system (not shown), for regulating the temperature of at least the microfluidic device 100 (in particular, for regulating the temperature in the control volume 112). The temperature regulation sub-system can include various temperature transducers and various heaters (e.g. heat jackets) for regulating the temperature of the microfluidic device 100 by heating the manifold 602, for regulating the temperature of the storage cylinder 606, and for regulating the temperature of various fluid lines. In alternative examples, the temperature regulation sub-system can be configured to cool microfluidic device 100 and/or other parts of the system 600.

The microfluidic system 600 further includes an optical investigation sub-system 634 for optically accessing the control volume 112 (i.e. the entire control volume 112 or a portion thereof), and optionally other features of the microfluidic device 100. The optical investigation sub-system 634 can include, for example, one or more microscopes having a viewing window in which all or a portion of the control volume 112 can sit, one or more laser analysis systems, one or more photodiode analysis systems, one or more video cameras, and/or one or more still image cameras. The optical investigation sub-system 634 can be computerized and can further include image processing software and image analysis software. The image processing software can optionally automatically process images captured by the optical investigation sub-system, and the image analysis software can optionally automatically analyze images the processed images.

The microfluidic system 600 can further include a control sub-system (not shown) connected to the study fluid injection sub-system 604, the pressure regulation sub-system 620, the temperature regulation sub-system, and the optical investigation sub-system 634. The control sub-system can include one or more processors, which can receive, process, and/or store information received from the study fluid injection sub-system 604, the pressure regulation sub-system 620, the temperature regulation sub-system, and the optical investigation sub-system 634. For example, the control system can receive temperature information from the temperature transducers and pressure information from the pressure transducers 626. Furthermore, the control sub-system can send instructions to the study fluid injection sub-system 604, the pressure regulation sub-system 620, the temperature regulation sub-system, and/or the optical investigation sub-system 634. For example, the control sub-system can instruct the temperature regulation sub-system to increase and/or decrease the output of one or more of the heaters. The control sub-system can optionally provide automatic control of the microfluidic system 600. For example, the control sub-system can be configured to automatically instruct the temperature regulation sub-system to increase and/or decrease the output of one or more of the heaters based on the received temperature information. The control sub-system can provide similar instructions to the pressure regulation sub-system 620.

Methods of assessing one or more thermophysical properties of a study fluid, particularly a gas composition, will now be described. The methods will be described with reference to the microfluidic device 100 and the microfluidic system 600; however, the methods are not limited to the microfluidic device 100 and the microfluidic system 600, and the microfluidic device 100 and microfluidic system 600 are not limited to operation in accordance with the methods. Furthermore, for clarity, the methods with be described with reference to a certain sequence of steps (e.g. a given step may be described as “a first step” or “a second step”, or terms such as “then” or “next” may be used); however, unless expressly indicated as such in the claims, the methods are not limited to any particular sequence of steps.

In general, the methods can include loading a study fluid in the form of a gas composition (e.g. a dry gas, a wet gas, or a supercritical fluid) into the control volume 112 of the microfluidic chip 100 to fill the gas accumulation cell 122 with the study fluid, and then adjusting an operating condition (e.g. pressure and/or temperature) within the control volume 122 to a test condition (e.g. a test pressure and/or a test temperature), to condense a liquid from the study fluid. Due at least in part to capillary action, the liquid will then flow from the gas accumulation cell 122 into the capillary channels 124. While adjusting the operating condition and/or after the operating condition has been adjusted, a phase state and/or volume of the study fluid in the capillary channels is assessed by optically investigating at least some of the capillary channels (e.g. with the use of the optical investigation sub-system 634).

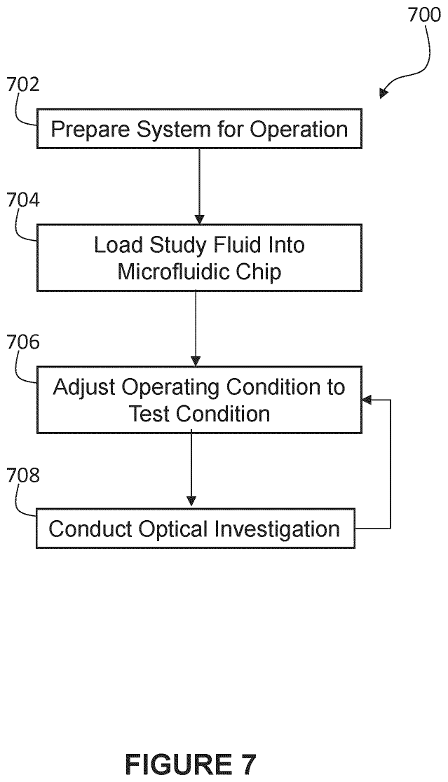

More specifically, an example method 700 for assessing the dew point pressure of a supercritical fluid is shown in FIG. 7. At the start of the method, the supercritical fluid is stored in the storage cylinder 606 and is maintained at a desired pressure using pump 608, and at a desired temperature using the temperature regulation sub-system.

At step 702, the system 600 is prepared for operation. That is, the temperature regulation sub-system is further engaged to heat the system 600 (i.e. at least the microfluidic chip and the various lines to a test temperature). The test temperature can be, for example, between about 25 degrees C. and about 200 degrees C. (e.g. about 99 degrees C.). Furthermore, valves 612, 614, 616, and 630 are opened, and pump 608 is engaged to transfer the supercritical fluid from the storage cylinder 606 to pumps 610 and 622. The storage cylinder 606 can then be isolated from the remainder of the system by closing valve 612.

At step 704, the supercritical fluid is loaded into the microfluidic chip 100—i.e. is loaded into the microfluidic chip 100 to fill the control volume 112 of the microfluidic chip 100 with the study fluid. This can be achieved by opening valves 614, 616, 618, 632 and 626, and engaging pump 610. The supercritical fluid thus enters the microfluidic chip 100 via both the fluid inlet port 108 and fluid outlet port 110. The inlet channel 114, bypass channel 118, gas accumulation cell 122, capillary channels 124, collection line system 126, and outlet channel 116 are thus filled with the supercritical fluid.

At step 706, after loading the supercritical fluid into the microfluidic chip 100, an operating condition within the control volume 112 is adjusted to a test condition. For example, the pressure within the control volume 112 can be isothermally decreased by opening valves 614, 618, 624, 626, and 630 and engaging pump 622 to lower the pressure within the control volume 112, to reach a test pressure. If the test pressure is equal to the dew point pressure or below the dew point pressure of the supercritical fluid, a liquid will condense from the study fluid. The liquid will initially form as a film in the gas accumulation cell 122, and then flow from the gas accumulation cell 122 into the capillary channels 124 by capillary action.

During and/or after step 706, an optical investigation can be conducted, at step 708. In particular, at least some of the capillary channels 124, and preferably all of the capillary channels 124 as well as the gas accumulation cell 122 and the collection line system 126 can be optically investigated. This can be done, for example, to assess a phase state and/or volume of the study fluid in the capillary channels 124 (or the control volume 112 as a whole). For example, the appearance of the first liquid droplet can be identified, and the volume thereof can be quantified. For further example, a volume of liquid in all of the capillary channels 124 (or the control volume 112 as a whole) at the test condition can be quantified, and/or a volume of gas in the capillary channels 124 (or the control volume 112 as a whole) at the test condition can be quantified. From these volumes, a condensate to gas ratio for the study fluid at the test condition can be calculated. The optical investigation can be carried out using the optical investigation sub-system 634.

If the pressure in the control volume is not initially decreased sufficiently to reach the dew point (e.g. if after a stabilization period of several minutes, liquid droplets do not form), then the pressure can again be decreased. The steps of lowering the pressure in the control volume 112 and conducting an optical investigation at the lowered pressure (i.e. steps 706 and step 708) can be repeated, optionally in a step-wise fashion, until the dew point pressure of the supercritical fluid is determined. For example, the steps can be repeated until a first liquid droplet is visible in images of the control volume 112. The steps of lowering the pressure in the control volume 112 and conducting an optical investigation can then continue to be repeated, to calculate the liquid dropout volume at subsequent pressures. Furthermore, quality lines can be plotted by assessing the pressure required to achieve a certain liquid or gas volume percentage.

In an alternative example, rather than or in addition to adjusting pressure, the temperature in the control volume 112 can be adjusted (e.g. the temperature can be lowered to reach the dew point temperature), while holding the pressure constant.

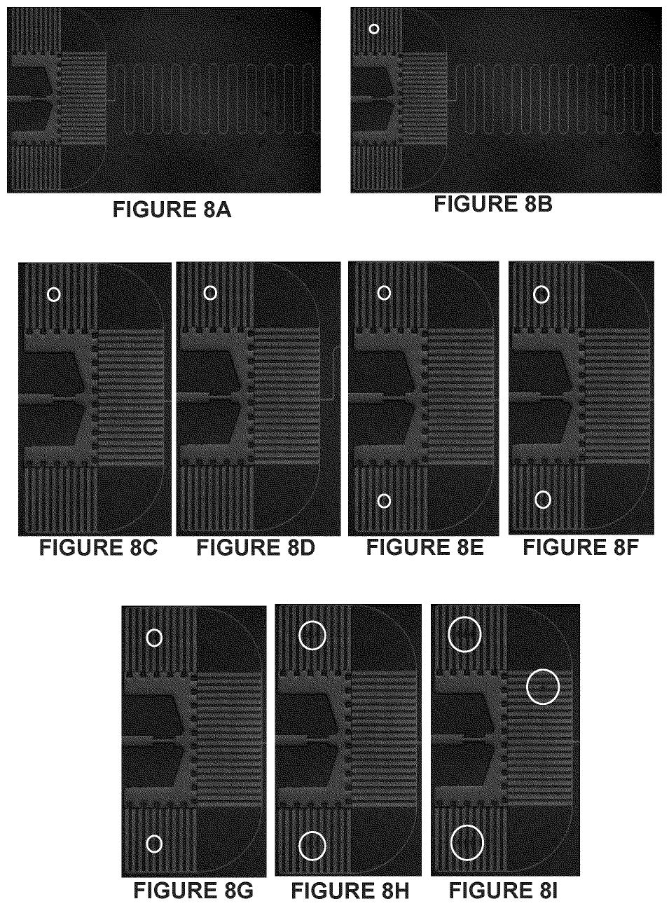

In a further alternative example, the method can be carried out with a traditional gas such as a dry gas or a wet gas (i.e. not a supercritical fluid), and over the course of the method, the operating pressure can be increased to condense a liquid from the study fluid. FIGS. 8A to 81 show images captured during the course of such a method. In FIG. 8A, the control volume is filled with gas and the operating pressure is 3.8 bar, i.e. below the dew point pressure. In FIG. 8B, the pressure has been increased to 5.1 bar—i.e. the dew point for the sample—and a droplet of liquid has formed (encircled). FIGS. 8C to 81 show increasing liquid dropout over time as equilibrium is reached. Using these images, the dew point pressure for the gas composition can be determined. Furthermore, with further increasing pressure (images not shown), the liquid dropout volume at various pressures can be calculated.

Referring now to FIGS. 9 to 11, an additional example of a microfluidic device is shown. Features in FIGS. 9 to 11 that are like those of FIGS. 1 to 5 will be identified to with like reference numerals as in FIGS. 1 to 5, incremented by 800. The microfluidic device 900 of FIGS. 9 to 11 may be used in the system 600 of FIG. 6, or in other systems. The microfluidic device 900 may be used according to the methods described above, or according to other methods.

Similarly to the microfluidic device 100 of FIGS. 1 to 5, the microfluidic device 900 includes a substrate 902 that has a control volume 912 (encircled in dotted line in FIG. 9), a fluid inlet port 908 that is in fluid communication with the control volume 912 via an inlet channel 914, a fluid outlet port 910 that is in fluid communication with the control volume 912 via an outlet channel 916, and a bypass channel 918 and bypass outlet 920. However, the control volume 912 is of a different configuration from that of FIGS. 1 to 5. Particularly, as can be seen in FIGS. 10 and 11, the gas accumulation cell 922 is generally linear (as opposed to U-shaped), and the capillary channels 924 (only four of which are labelled) extend from opposed sides of the gas accumulation cell 922. The capillary channels 924 then join to and are in communication with the collection line system 926.

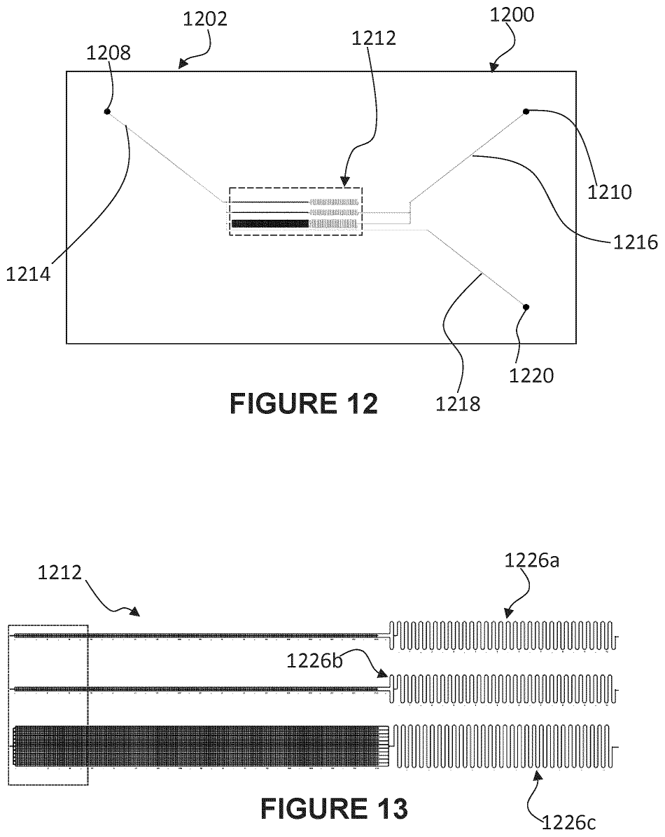

Referring now to FIGS. 12 to 14, an additional example of a microfluidic device is shown. Features in FIGS. 12 to 14 that are like those of FIGS. 1 to 5 will be identified to with like reference numerals as in FIGS. 1 to 5, incremented by 1100. The microfluidic device 1200 of FIGS. 12 to 14 may be used in the system 600 of FIG. 6, or in other systems. The microfluidic device 1200 may be used according to the methods described above, or according to other methods.

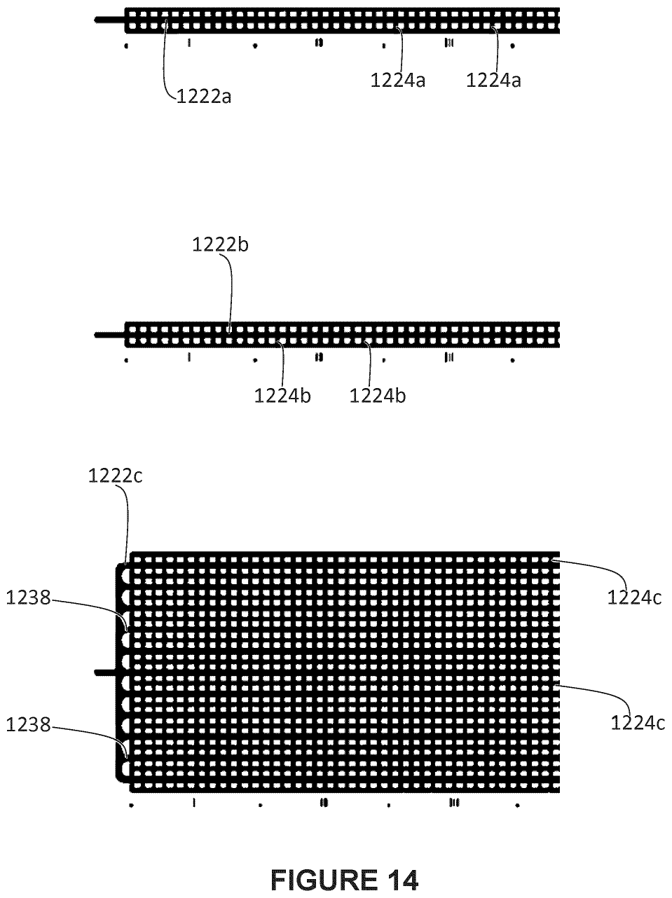

Similarly to the microfluidic device 100 of FIGS. 1 to 5, the microfluidic device 1200 includes a substrate 1202 that has a control volume 1212 (encircled in dotted line in FIG. 12), a fluid inlet port 1208 that is in fluid communication with the control volume 1212 via an inlet channel 1214, a fluid outlet port 1210 that is in fluid communication with the control volume 1212 via an outlet channel 1216, and a bypass channel 1218 and bypass outlet 1220. However, the control volume 1212 is of a different configuration from that of FIGS. 1 to 5. Particularly, as can be seen in FIGS. 13 and 14, the control volume includes three gas accumulation cells 1222a, 1222b, and 1222c (i.e. first through third gas accumulation cells), each of which has a respective set of capillary channels 1224a, 1224c, 1224c. The gas accumulation cell 1222a and capillary channels 1224a are configured similarly to those of FIGS. 9 to 11, as are the gas accumulation cell 1222b and capillary channels 1224b. The gas accumulation cell 1222c includes a set of linear gas accumulation channels 1238 (only two of which are labelled), and the capillary channels 1224c are arranged in a grid-like configuration. A collection line system 1226a is in fluid communication with the capillary channels 1224a; a collection line system 1226b is fluid communication with the capillary channels 1224b; and a collection line system 1226c is fluid communication with the capillary channels 1224c. Furthermore, the inlet channel 1214 is branched to join with each of the three gas accumulation cells 1222a, 1222b, and 1222c, and the outlet channel 1216 is branched to join with each of the three collection line systems 1226a, 1226b, 1226c.

While the microfluidic device 1200 has been described above as including a single control volume 1212 with three gas accumulation cells 1222a, 1222b, and 1222c (each of which has a respective set of capillary channels 1224a, 1224b, 1224c), it may alternatively be described as including three control volumes 1212a, 1212b, 1212c, each of which has a single gas accumulation cell (i.e. gas accumulation cell 1222a, gas accumulation cell 1222b, and gas accumulation cell 1222c, respectively).

Referring now to FIGS. 15 and 16, an additional example of a microfluidic device is shown. Features in FIGS. 15 and 16 that are like those of FIGS. 1 to 5 will be identified to with like reference numerals as in FIGS. 1 to 5, incremented by 1400. The microfluidic device 1500 of FIGS. 15 and 16 may be used in the system 600 of FIG. 6, or in other systems. The microfluidic device 1500 may be used according to the methods described above, or according to other methods.

Referring first to FIG. 15, the microfluidic device 1500 includes a substrate 1502 that has twelve control volumes 1512 (i.e. first through twelfth control volumes, only four of which are labelled in FIG. 15), which are arranged in a four by three grid. The microfluidic device further includes a first inlet port 1510a and a bypass outlet 1520, which are in fluid communication via a bypass channel 1518. The bypass channel is in fluid communication with each of the control volumes 1512 via an inlet channel 1514, which is branched to join to each of the control volumes 1512, and which includes a serpentine section. The microfluidic device further includes a fluid outlet port 1508, which is in fluid communication with each of the control volumes 1512 via an outlet channel 1516, which is branched to join to each of the control volumes 1512, and which includes a serpentine section. The microfluidic device further includes a second inlet port 1510b, which may be provided for redundancy, and which is in fluid communication with the first inlet port 1510a.

Referring to FIG. 16, a first one of the control volumes 1512 is shown in greater detail, and is encircled in dotted line. The remaining eleven control volumes 1512 are similar to or identical to the first control volume 1512, and are not described in detail. The first control volume 1512 includes a gas accumulation cell 1522 that includes two linear gas accumulation channels 1538, and a set of capillary channels 1524 (only two of which are labelled) that are arranged in a grid-like configuration.

Referring still to FIG. 16, in this example, the collection line system is omitted. Instead, the capillary channels 1524 are in fluid communication with the outlet channel 1516 via a secondary gas accumulation cell 1540. The secondary gas accumulation cell 1540 differs from the collection line system in that it is significantly deeper than the capillary channels, for example of the same depth as the gas accumulation cell 1522. Accordingly, in use, if the test pressure is sufficient to cause condensation, a liquid will condense from the study fluid in the secondary gas accumulation cell 1540, and then flow from the secondary gas accumulation cell 1540 into the capillary channels 124 by capillary action.

While the above description provides examples of one or more processes or apparatuses or compositions, it will be appreciated that other processes or apparatuses or compositions may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

1. A microfluidic device for assessing one or more thermophysical properties of a study fluid, comprising:
a microfluidic substrate having at least a first fluid inlet port, at least a first fluid outlet port, and at least a first control volume in fluid communication with the first fluid inlet port and the first fluid outlet port;
wherein the first control volume comprises
at least a first gas accumulation cell downstream of and in fluid communication with the first fluid inlet port for accumulating a gas composition within the control volume; and
a plurality of capillary channels downstream of the first gas accumulation cell for collecting condensed liquid from the first gas accumulation cell, wherein the capillary channels each extend from the first gas accumulation cell, wherein a depth of each of the capillary channels is less than a depth of the first gas accumulation cell, and wherein the first fluid outlet port is downstream of and in fluid communication with the capillary channels.

2. The microfluidic device of claim 1, wherein the depth of the first gas accumulation cell is micron-scale, and the depth of the capillary channels is nanometer-scale.

3. The microfluidic device of claim 1, wherein the depth of the first gas accumulation cell is between about 1 micron and about 500 microns and the depth of each of the capillary channels is between about 80 nm and about 1 micron.

4. (canceled)

5. (canceled)

6. (canceled)

7. The microfluidic device of claim 1, wherein a volume of the first gas accumulation cell is between about 0.0000912 mm³ and about 0.0456 mm³ and a respective volume of each capillary channel is between about 0.000000432 mm³ and about 0.0000054 mm³.

8. (canceled)

9. (canceled)

10. (canceled)

11. The microfluidic device of claim 1, wherein a length of each respective capillary channel is between about 20 microns and about 500 microns, and a width of each respective capillary channel is between about 2 microns and about 80 microns.

12. (canceled)

13. The microfluidic device of claim 1, wherein the first gas accumulation cell has a periphery from which the capillary channels extend, and wherein the first gas accumulation cell further comprises a plurality of pillars positioned around the periphery and adjacent the capillary channels to facilitate nucleation.

14. The microfluidic device of claim 1, wherein the first gas accumulation cell is generally linear or generally U-shaped.

15. (canceled)

16. The microfluidic device of claim 1, wherein the first gas accumulation cell is in fluid communication with the first fluid inlet port via an inlet channel, and wherein the microfluidic device further comprises a bypass channel extending from the inlet channel and in fluid communication with a bypass outlet.

17. The microfluidic device of claim 1, wherein the first fluid outlet port is in fluid communication with the capillary channels via a collection line system for collecting condensed liquid from the capillary channels.

18. The microfluidic device of claim 17, wherein the collection line system comprises a first collection line that is joined to and in fluid communication with each of the capillary channels, and a second collection line that extends from the first collection line towards the first fluid outlet.

19. The microfluidic device of claim 17, wherein a depth of the collection line system is the same as the depth of the capillary channels.

20. (canceled)

21. The microfluidic device of claim 1 wherein the plurality of capillary channels comprises between 20 and 1000 capillary channels.

22. (canceled)

23. A method for assessing one or more thermophysical properties of a study fluid, comprising:
a. loading the study fluid into at least a first control volume of a microfluidic chip to fill at least a first gas accumulation cell of the microfluidic chip with the study fluid;
b. after step a., adjusting an operating condition within the first control volume to a test condition, to condense a liquid from the study fluid, whereby the liquid flows from the first gas accumulation cell into a plurality of capillary channels extending from the gas accumulation cell; and
C. during and/or after step b., optically investigating at least some of the capillary channels to assess a phase state and/or volume of the study fluid in the capillary channels.

24. The method of claim 23, wherein in step b., the liquid flows from the first gas accumulation cell into the plurality of capillary channels at least partially by capillary action.

25. The method of claim 23, wherein in steps a., b., and c., the microfluidic chip is oriented horizontally.

26. The method of claim 23, wherein step c. comprises at least one of: assessing a volume of the liquid in the capillary channels at the test condition, assessing a volume of a gas composition in the capillary channels at the test condition, assessing a volume of the liquid in the control volume at the test condition, assessing a volume of the gas composition in the control volume at the test condition, and assessing a condensate to gas ratio for the study fluid at the test condition.

27. The method of claim 23, further comprising repeating steps b. and c. at subsequent test conditions and plotting a phase envelope for the study fluid.

28. (canceled)

29. The method of claim 23, wherein the operating condition is pressure or temperature.

30. (canceled)

31. The method of claim 23,
wherein in step a., the study fluid is a supercritical fluid, and step b. comprises isothermally depressurizing the control volume to condense the liquid from the supercritical fluid; or
wherein in step a., the study fluid is a traditional gas, and step b. comprises isothermally pressurizing the control volume to condense the liquid from the traditional gas.

32. (canceled)

33. A microfluidic system for assessing one or more thermophysical properties of a study fluid, the microfluidic system comprising:
a microfluidic device having at least a first fluid inlet port, at least a first fluid outlet port, and at least a first control volume in fluid communication with the first fluid inlet port and the first fluid outlet port, wherein the first control volume comprises i) at least a first gas accumulation cell downstream of and in fluid communication with the first fluid inlet port for accumulating a gas composition within the first control volume, and ii) a plurality of capillary channels downstream of the first gas accumulation cell for collecting condensed liquid from the first gas accumulation cell, wherein the capillary channels each extend from the first gas accumulation cell, wherein a depth of each of the capillary channels is less than a depth of the first gas accumulation cell, and wherein the first fluid outlet port is downstream of and in fluid communication with the capillary channels;
a study fluid injection sub-system in fluid communication with the first fluid inlet port for forcing a study fluid into the first control volume to fill the first control volume;
a pressure regulation sub-system for regulating the pressure in the first control volume;
a manifold supporting the microfluidic device and providing fluid communication between the microfluidic device, the study fluid injection sub-system, and the pressure regulation sub-system;
a temperature regulation sub-system for regulating the temperature in at least the control volume; and
an optical investigation sub-system for optically accessing at least a portion of the control volume.
